(19) United States
(12) Patent Application Publication
(10) Pub. No.: US 2016/0123242 A1
(43) Pub. Date: May 5, 2016

(54) Engine Braking

(71) Applicant: INTERNATIONAL ENGINE INTELLECTUAL PROPERTY COMPANY, LLC, Lisle, IL (US)

(72) Inventor: Bruce Winfield Hamilton, Plainfield, IL (US)

(73) Assignee: International Engine Intellectual Property Company, LLC, Lisle, IL (US)

(21) Appl. No.: 14/893,553

(22) PCT Filed: May 29, 2013
(86) PCT No.: PCT/US13/42970

§ 371 Date: Nov. 24, 2015

(51) Int. Cl. F02D 13/04; F02D 41/34

(52) U.S. Cl. CPC F02D 13/04; F02D 41/345

(57) ABSTRACT

A method for enhancing engine brake horsepower. The method includes generating an engine brake horsepower by compressing air in a cylinder of an engine. Additionally, fuel is injected into the compressed air in the cylinder. The injected fuel is combusted in the compressed air in the cylinder prior to the piston reaching the top dead center position in the at least one cylinder. The compressed combustion products are also released before the piston passes the top dead center position. The combustion of the fuel during the engine braking event allows the engine braking to be a throttable event. Further, the quantity of fuel introduced into the cylinder for combustion may be adjusted so that the engine braking horsepower remains relatively consistent despite changes in engine speed.

### BACKGROUND

Engine brakes, including compression release brakes, are typically used in vehicles having an internal combustion engine to retard vehicle speed when deceleration is desired as well as maintain constant vehicle speed while a vehicle is descending a downhill grade. Compression release brakes are controlled by a vehicle operator and function only once the driver has released, or is no longer engaging, the accelerator, such as releasing the operator's foot from the accelerator pedal. In this circumstance, engine brakes as embodied today are passive devices that use no fuel of any variety, but instead convert a vehicles momentum into retarding (engine braking) power to maintain or retard vehicle speed as desired. Engine braking may provide a way for slowing the movement of a vehicle that assists, or in certain circumstances operates in lieu of, traditional service brakes, such as friction brakes or magnetic brakes.

Traditionally, an engine brake, such as, for example, a two or four-cycle Jake brake, develops its braking horse power by converting a moving vehicles forward momentum into mechanical work. More specifically, when the driver is not engaging the vehicle's accelerator, and the supply of fuel to the cylinders is shut off, the rolling of the tries or wheels of the vehicle causes the continued movement of the vehicle's drivetrain. Such continued movement of the drivetrain forces the crankshaft to continue to rotate, which is translated into the continued displacement of the pistons within the cylinders. Accordingly, as such displacement of the pistons includes the pistons undergoing a compression stroke, air within the cylinder continues to be compressed as the pistons are displaced toward a top dead center position in the cylinder. With compression release braking, the pressure of such compressed air in the cylinder provides a force that generally opposes this displacement of the piston. Moreover, the opposing force, or engine braking horsepower, of the compressed air during such a compression stroke may slow the movement of the pistons, and thereby assist in slowing the momentum of the vehicle.

Further, when the piston approaches, reaches, or passes an upper position in the cylinder, such as the top dead center position, the compressed air may be released from the cylinder, such as through an exhaust valve in the cylinder head. An intake valve may then be re-opened so that intake air that is to be pressurized by the subsequent compression stroke enters into the cylinder. According to certain applications, this process may continue to be repeated until the engine speed and/or vehicle is reduced to a desired level, such as, for example, the crankshaft being reduced to a desired range of revolutions per minute (rpm) (e.g. 1000 rpm).

As the compression utilized by engine release brakes is only being generated while the vehicle is moving, and engine release brakes do not contributes energy of their own, such engine brakes are passive devices. Moreover, as these engine brakes do not contribute energy of its own, their performance is typically limited by the engine speed (rpm) and the structure of the engine and/or vehicle systems, including, for example, such systems related to the air induction/exhaust systems, engine displacement, valve motion/timing intake and exhaust port designs, and the transmission and drive train gearing.

### BRIEF SUMMARY

In one embodiment, a method for improving engine brake horsepower is provided. The method includes introducing a fuel into at least one cylinder of an engine during an engine braking event. Additionally, the fuel introduced into the at least one cylinder is combusted during a compression stroke of a piston in the cylinder during the engine braking event to increase pressure acting against piston motion and enhance the engine brake horsepower.

In another embodiment, a method for enhancing engine brake horsepower for retarding the forward momentum of a vehicle is provided. The method includes generating an engine brake horsepower by compressing air in at least one cylinder of an engine. Additionally, fuel is injected into the compressed air in the at least one cylinder. The injected fuel is combusted in the compressed air in the at least one cylinder before the piston reaches a top dead center position in the at least one cylinder. The compressed combustion products are also released before the piston passes the top dead center position.

According to another embodiment, a method for enhancing engine brake horsepower for retarding the forward momentum of a vehicle that includes ceasing, at least temporarily, the production of positive power by an internal combustion engine that is used to drive a drivetrain. Additionally, air is compressed in a cylinder of the engine to generate an engine braking force. The quantity of fuel to be introduced into the compressed air is also determined, and the fuel is injected into the compressed air while a position in the cylinder is moving toward a top dead center position. The injected fuel is also combusted in the compressed air before the piston reaches the top dead center position to generate a further engine braking force. The compressed combustion products of the air and fuel are then released before the piston passes the top dead center position.

### BRIEF DESCRIPTION OF SEVERAL VIEWS OF THE DRAWINGS

FIG. 1 is an exemplary representation of a portion of a four-stroke internal combustion engine.

FIG. 2 is a flow chart illustrating the use of a combustion event to booster the speed retarding horsepower of the engine brake.

FIG. 3 is a chart illustrating recorded engine braking power for a Cummins 15L ISX engine and two and four stroke Maxxforce engines without the benefit of a combustion event, as well as the projected engine braking horsepower of an engine that has fuel combusted during the compression stroke for either a 2-cycle or 4-cycle Maxxforce 13L internal combustion engine.

### DETAILED DESCRIPTION

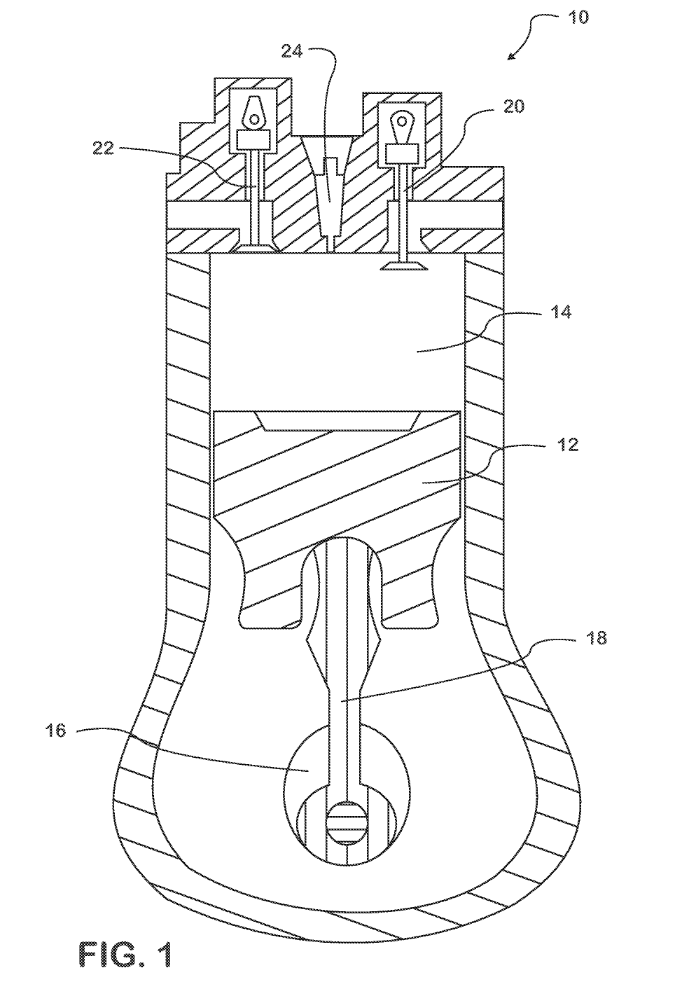

For illustration purposes, FIG. 1 is an exemplary representation of a portion of a four-stroke internal combustion engine 10. More specifically, FIG. 1 illustrates a piston 12 housed in a cylinder 14 of the engine 10. The piston 12 may be operably connected to the crankshaft 16, such as by a connecting rod 18. The control of air into and out of the cylinder 14 may be controlled by the actuation of intake and exhaust valves 20, 22, respectively. Additionally, fuel may be introduced into the cylinder 14 by a variety of different devices, such as, for example, through a fuel injector 24.

In an effort to assist slowing and/or stopping the movement of the vehicle, some vehicles are equipped with an engine brake. The activation of the engine brake may be manually controlled by the operator of the vehicle, such as, for example, by a switch that provides the option of turning the engine brake feature on or off. Alternatively, the engine brake may be activated or deactivated automatically, such as, for example by the engine control unit (ECU). Accordingly, during certain periods of vehicle operation, such as, for example, while driving on a flat road with minimal traffic, the benefits of an engine brake may not be desired by the driver. In such situations, the engine brake may be deactivated by the driver. However, during other periods of operation, such as while attempting to reduce the speed of a vehicle that is descending downhill grades, such as mountainous or hilly areas, the engine brake feature may be turned on by the driver and then may be activated or deactivated automatically by the ECU such that the engine brake may assist in reducing and/or controlling the speed of the vehicle. Further, in such situations, the use of the engine brake may prevent wear, damage and/or a total loss of the vehicle's service brakes that can otherwise lead to runaway vehicle situations.

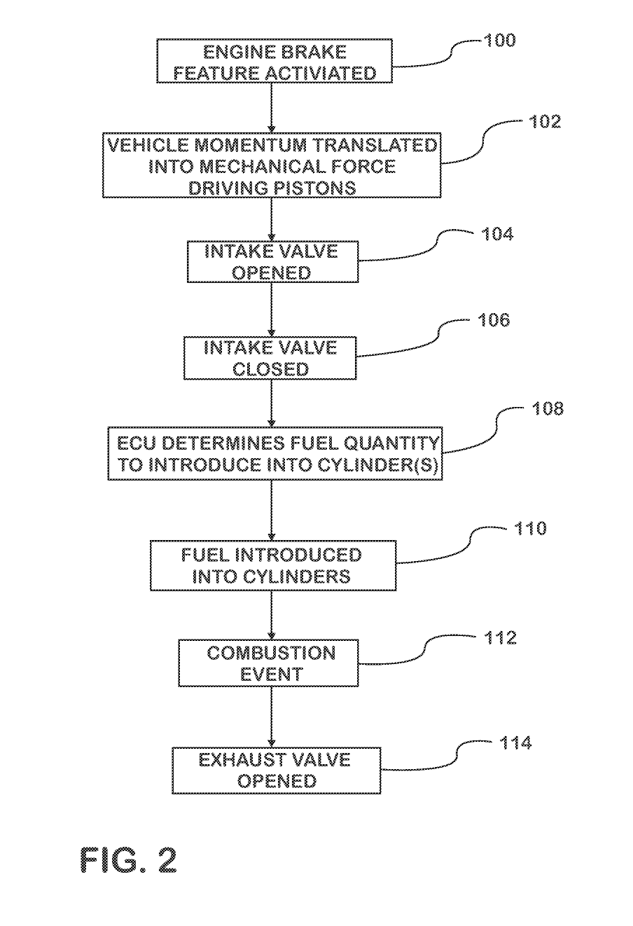

Referencing FIGS. 1 and 2, during typical operation of an engine brake, at step 100, the engine brake is activated, such as by the operator of the vehicle switching or having an engine brake switch to/in an “on” position or the engine brake being automatically placed in an activated condition. Such activation of the engine brake may also include the operator of the vehicle releasing the accelerator or throttle so as to cease the flow of fuel into the cylinder 14 that may otherwise be used to power the forward momentum of the vehicle, such as by powering the drivetrain. At step 102, as the vehicle continues to move forward, the vehicle's movement causes the piston 12 to move between the top and bottom dead center positions in the cylinder 14. When using the engine compression brake, during an intake stroke, at step 104 the intake valve 20 opens as the piston 14 moves towards the bottom dead center position so that air may flow into the cylinder 14. At step 106, the intake valve 20 is closed so that, during a compression stroke when the piston 12 moves toward the top dead center position, the intake air is prevented from escaping from the cylinder 14 through the closed intake or exhaust valves 20, 22. Thus, during the compression stroke, the movement of the vehicle, and associated mechanical work, is used to move the piston 12 toward the top dead center position, and thereby compress the air that is in the cylinder 14. The resulting compressed air however provides a force that opposes the displacement of the piston 12 toward the top dead center position, and which is used to slow the movement of the piston and thereby slow the movement of the associated vehicle.

According to illustrated embodiments, after completion of the intake stroke, at step 110, a metered quantity to fuel, such as, for example, diesel, gasoline, or natural gas, among others, is introduced into the cylinder 14. For example, according to certain embodiments, a metered amount of fuel may be injected into the air in the cylinder 14 by the fuel injector 24 when the piston 14 is at or near the bottom dead center position, after completion of the intake stroke, and/or near the start of the compression stroke.

The quantity and timing of the fuel introduced into the cylinder 14 may be determined and/or controlled by an engine control unit (ECU) at step 108. Moreover, the ECU may include a brake strategy or logic that is used to determine the amount of fuel that should be, or should not be, introduced for combustion in the cylinder 14 during engine braking. Such a strategy or logic may consider a number of different factors when determining the amount of fuel that is to be introduced into the cylinder 14, including for example, the speed of the engine (rpm), barometric pressure, and vehicle altitude. Further, engine durability factors may also be taken into consideration when determining the quantity of fuel that is to be injected into the cylinder 14. For example, the quantity of injected fuel may, for engine braking purposes, provide an engine braking horsepower that does not exceed the maximum desired positive horsepower typically generated by the engine when combustion events are used for driving of the vehicle. Additional considerations may include, but are not limited to compression ratio, displacement, and the quantity of intake air boost. Although illustrated as occurring at step 108, the determination of the amount of fuel to be introduced into the cylinder 14, as well as introduction of the determined amount of fuel into the cylinder 14, may occur at any number of different times prior to or during an engine braking event(s).

At step 112, the fuel introduced into the cylinder 14 may be combusted at a desired point during the compression stroke. For example, the fuel introduced into the cylinder 14 may be combusted through the operation of the vehicle's ignition system, such as, for example, by the firing of a spark plug or a glow plug. The combustion of the fuel in the cylinder 14 provides a force in addition to that provided by the pressure of the air being compressed in the cylinder 14 that allows for an increase in the overall braking horsepower of the engine brake. Thus, introduction of fuel into the cylinder 14 introduces a way to increase the braking horsepower of the engine brake beyond the levels typically obtainable when the engine brake is a passive device, and more specifically, exceed the limitations on engine brake horsepower that are otherwise related to engine/vehicle hardware limitations. Moreover, the use of such a combustion event allows the engine brake to become a throttable, powered function that can be controlled to a specific set-point.

When the piston is at or near the top dead center position, at step 114, the exhaust valve 22 may be opened so that the compressed, combusted air is released from the cylinder 14 and may pass into the vehicle exhaust system. Such a release prevents the compressed, combusted air from expanding in the cylinder 14 during the down stroke of the piston 12, which may otherwise cause the energy of the compressed, combusted air to return to the vehicle. Accordingly, with the piston 12 at or in proximity to the top dead center position, there may be minimum volume of compressed air in the cylinder 14. Additionally, the exhaust valve 22 may remain open as the piston 12 descends from the top dead center position. Further, the exhaust valve 22 may also remain open as the piston 12 subsequently ascends from the bottom dead center position to the top dead center position during an exhaust stroke in which non-compressed gases may be pushed out of the cylinder 14 and into the exhaust stream.

Although the illustrated embodiments have been discussed with respect to four-stroke engines, the introduction of fuel to assist engine braking may also be used by other types of engines, including, for example, two-stroke engines. For example, like a four-stroke engine, with a two-stroke engine fuel may be introduced into the cylinder to increase the braking horsepower of the engine brake. Further, the introduction of fuel in engine braking with the two-stroke engine may occur at or around the time the piston begins the up, or compression, stroke. The ignition system may then trigger the combustion of the fuel in the chamber during the compression stroke, such as by firing a spark plug or glow plug at a set point during the compression stroke.

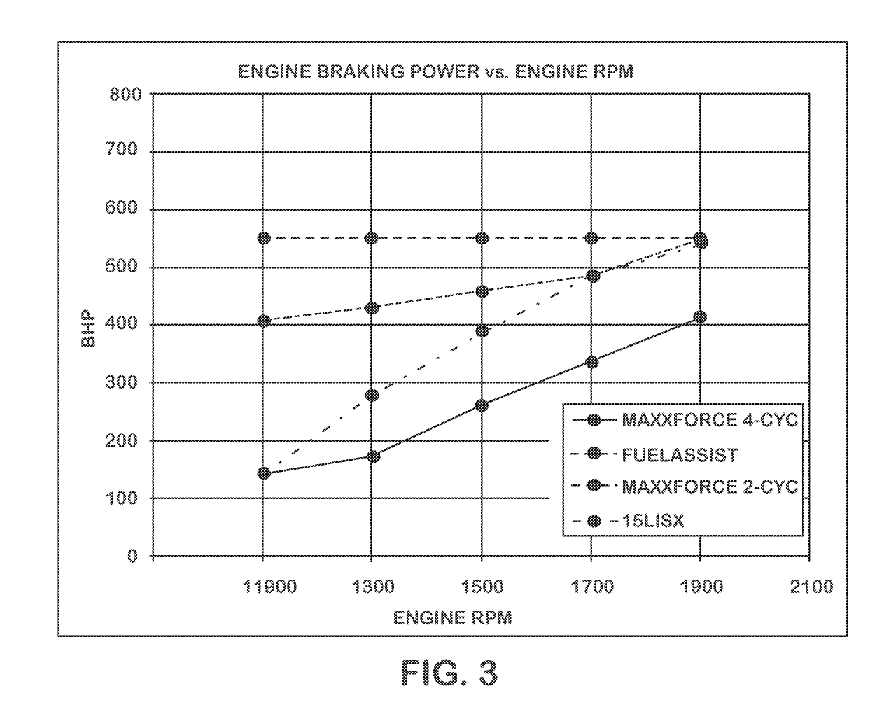

FIG. 3 is a chart illustrating recorded engine braking power for a Cummins 15L ISX engine and Maxxforce two and four stroke engines without the benefit of a combustion event, as well as the projected engine braking horsepower of either a 2 cycle or a 4 cycle Maxxforce 13L engine that has fuel combusted during the compression stroke. As illustrated, for those engines that do not have the benefit of a combustion event during the compression stroke, engine braking horsepower (BHP) is adversely impacted by a decrease in engine speed. For example, FIG. 3 illustrates a relatively significant decrease in engine brake horsepower for the four cycle engines (Maxxforce 4 cycle and 15L ISX) as engine speed decreases. Conversely, the introduction of fuel into the combustion chamber and subsequent combustion event during the compression stroke allows the BHP to be maintained at a relatively consistent level. Moreover, the ability to adjust the quantity of fuel introduced into the cylinder 14, and thereby control the size of the combustion event, allows for the engine brake to be throttable such that adjustments may be made to quantity of fuel introduced into the cylinder 14 as the engine speed changes. For example, as engine speed decreases, the quantity of fuel introduced into the cylinder 14 may increase to increase the force generated from the combustion event in the cylinder 14 that is used to oppose the displacement of the piston 12 toward the top dead center position.

1. A method for improving engine brake horsepower comprising:
introducing a fuel into at least one cylinder of an engine; and
combusting the introduced fuel during a compression stroke of a piston in the cylinder during an engine braking event to enhance the engine brake horsepower.

2. The method of claim 1, further including the step of releasing the accelerator of the vehicle so as prevent the introduction of an additional fuel into the cylinder that is used to power the drivetrain of the vehicle.

3. The method of claim 2, wherein the step of releasing the accelerator further includes stopping the flow of the additional fuel into the at least one cylinder.

4. The method of claim 1 further including the step of determining the quantity of fuel to be introduced into the at least one cylinder.

5. The method of claim 4, wherein the step of determining the quantity of fuel to be introduced includes adjusting the quantity of fuel to be introduced based on a speed of the engine.

6. The method of claim 4, further including opening an exhaust valve before completion of the compression stroke.

7. The method of claim 1, wherein the engine is a two stroke engine.

8. The method of claim 1, wherein the engine is a four stroke engine.

9. A method for enhancing engine brake horsepower for retarding the forward momentum of a vehicle, the method comprising:
generating an engine brake horsepower by compressing air in at least one cylinder of an engine;
injecting fuel into the compressed air in the at least one cylinder;
combusting the injected fuel in the compressed air in the at least one cylinder before the piston reaches a top dead center position in the at least one cylinder; and
releasing the compressed air before the piston passes the top dead center position.

10. The method of claim 9 further including the step determining the quantity of fuel to be introduced into the at least one cylinder.

11. The method of claim 10, wherein the step of determining the quantity of fuel to be introduced includes adjusting the quantity of fuel to be introduced based on a speed of the engine.

12. The method of claim 1, wherein the engine is a two stroke engine.

13. The method of claim 1, wherein the engine is a four stroke engine.

14. A method for enhancing engine brake horsepower for retarding the forward momentum of a vehicle, the method comprising:
ceasing, at least temporarily, the production of positive power by an internal combustion engine that is used to drive a drivetrain;
compressing air in a cylinder of the engine to generate an engine braking force;
determining the quantity of fuel to be introduced into the compressed air;
injecting fuel into the compressed air while a position in the cylinder is moving toward a top dead center position;
combusting the injected fuel in the compressed air before the piston reaches the top dead center position to generate a further engine braking force; and
releasing the compressed air before the piston passes the top dead center position.

15. The method of 114, wherein the step of determining the quantity of fuel to be injected into the cylinder includes determining the speed of the engine.
